(19) United States
(12) Patent Application Publication
(10) Pub. No.: US 2025/0054042 A1
(43) Pub. Date: Feb. 13, 2025

(54) SYSTEMS AND METHODS FOR PREDICTING USER INTENT

(71) Applicant: IDG Communications, Inc., Needham, MA (US)

(72) Inventors: Brendan Brady, Brooklyn, NY (US); Jun Hong Choi, San Francisco, CA (US); Manoj Kumar Goyal, Union City, CA (US); Max Gross, New York, NY (US); Kumaran Ramanathan, Bromley (GB); Jason Ryan Tenenbown, Mill Valley, CA (US)

(21) Appl. No.: 18/798,513

(22) Filed: Aug. 8, 2024

Related U.S. Application Data
(60) Provisional application No. 63/518,512, filed on Aug. 9, 2023.

(51) Int. Cl. G06Q 30/0601

(52) U.S. Cl. CPC G06Q 30/0629; G06Q 30/0631

(57) ABSTRACT

Systems, methods, and computer-readable storage media for predicting user interest, and more specifically to defining user interest based on user expressions of intent. The system can receive a list of items, where each item in the list of items has a similar purpose and can be substituted with other items in the list of items, and item content elements associated with items in the list. The system can then identify websites with content that is relevant to the item content elements associated with the list based on relevancy, and identify at least one user that accessed one of the websites, resulting in at least one interested user. The system can then generate, for each user in the set of at least one interested users, a user intent and modify a previously planned interaction with the each user based on the user intent score.

### CROSS-REFERENCE

This application claims priority to U.S. provisional patent application No. 63/518,512 filed Aug. 9, 2023, the contents of which are incorporated herein in their entirety.

### BACKGROUND

### 1. Technical Field

The present disclosure relates to predicting user intent, and more specifically to defining user intent based on user expressions.

### 2. Introduction

Marketing is the activity or business of promoting and selling items or services. A goal of marketing is converting interested individuals into customers. However, marketing and selling to individuals which do not have sufficient intent in an item or service can be an inefficient use of resources.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, a list of items, where each item in the list of items has a similar purpose and can be substituted with other items in the list of items; identifying, via at least one processor of the computer system, a plurality of keywords that users of the computer system associate with items in the list of items; identifying, via the at least one processor of the computer system, a plurality of websites with content that is relevant to the plurality of keywords associated with the items in the list of items; identifying, via the at least one processor using network traffic data, at least one user that accessed at least one of the plurality of websites, resulting in a set of at least one interested users; generating, via the at least one processor for each user in the set of at least one interested users, a user intent score, the user intent score indicating a user interest level of the each user in the items in the list of items; and modifying, via the at least one processor, a previously planned interaction with the each user based on the user intent score.

A system configured to perform the concepts disclosed herein can include: at least one processor; and a non-transitory computer-readable storage medium having instructions stored which, when executed by the at least one processor, cause the at least one processor to perform operations comprising: receiving a list of items, where each item in the list of items has a similar purpose and can be substituted with other items in the list of items; identifying a plurality of keywords that users of the system associate with items in the list of items; identifying a plurality of websites with content that is relevant to the plurality of keywords associated with the items in the list of items; identifying, using network traffic data, at least one user that accessed at least one of the plurality of websites, resulting in a set of at least one interested users; generating, for each user in the set of at least one interested users, a user intent score, the user intent score indicating a user interest level of the each user in the items in the list of items; and modifying a previously planned interaction with the each user based on the user intent score.

A non-transitory computer-readable storage medium configured as disclosed herein can have instructions stored which, when executed by at least one processor, cause the at least one processor to perform operations which include: receiving a list of items, where each item in the list of items has a similar purpose and can be substituted with other items in the list of items; identifying a plurality of keywords that users associate with items in the list of items; identifying a plurality of websites with content that is relevant to the plurality of keywords associated with the items in the list of items; identifying, using network traffic data, at least one user that accessed at least one of the plurality of websites, resulting in a set of at least one interested users; generating, for each user in the set of at least one interested users, a user intent score, the user intent score indicating a user interest level of the each user in the items in the list of items; and modifying a previously planned interaction with the each user based on the user intent score.emb

A method for performing the concepts disclosed herein can include: receiving, at a computer system, a list of items, where each item in the list of items has a similar purpose and can be substituted with other items in the list of items; identifying, via at least one processor of the computer system, a set of item content elements associated with items in the list of items; generating, via the at least one processor, a content embedding based on at least one element of content within the set of item content elements, the content embedding encoding a relevancy of the at least one element of content to the list of items; identifying, via the at least one processor of the computer system, a plurality of websites with website content that is relevant to the list of items, the relevancy of the website content determined by comparing item content embeddings with content embeddings for the website content; identifying, via the at least one processor using network traffic data, at least one user that accessed at least one of the plurality of websites, resulting in a set of at least one interested users; generating, via the at least one processor for each user in the set of at least one interested users, a user intent score, the user intent score indicating a user interest level of the each user in the items in the list of items; and modifying, via the at least one processor, a previously planned interaction with the each user based on the user intent score.

A system configured to perform the concepts disclosed herein can include: at least one processor; and a non-transitory computer-readable storage medium having instructions stored which, when executed by the at least one processor, cause the at least one processor to perform operations comprising: receiving a list of items, where each item in the list of items has a similar purpose and can be substituted with other items in the list of items; identifying a set of item content elements associated with items in the list of items; generating a content embedding based on at least one element of content within the set of item content elements, the content embedding encoding a relevancy of the at least one element of content to the list of items; identifying a plurality of websites with website content that is relevant to the plurality of keywords associated with the items in the list of items, the relevancy of the website content determined by comparing item content embeddings with content embeddings for the website content; identifying, using network traffic data, at least one user that accessed at least one of the plurality of websites, resulting in a set of at least one interested users; generating, for each user in the set of at least one interested users, a user intent score, the user intent score based on the relevancy of the website content, the user intent score indicating a user interest level of the each user in the items in the list of items; and modifying a previously planned interaction with the each user based on the user intent score.

A non-transitory computer-readable storage medium configured as disclosed herein can have instructions stored which, when executed by at least one processor, cause the at least one processor to perform operations which include: receiving a list of items, where each item in the list of items has a similar purpose and can be substituted with other items in the list of items; identifying a set of item content elements associated with items in the list of items; generating, via the at least one processor, a content embedding based on at least one element of content within the set of item content elements, the content embedding encoding a relevancy of the at least one element of content to the list of items; identifying a plurality of websites with website content that is relevant to the list of items, the relevancy of the website content determined by comparing item content embeddings with content embeddings for the website content; identifying, using network traffic data, at least one user that accessed at least one of the plurality of websites, resulting in a set of at least one interested users; generating, for each user in the set of at least one interested users, a user intent score, the user intent score based on the relevancy of the website content, the user intent score indicating a user interest level of the each user in the items in the list of items; and modifying a previously planned interaction with the each user based on the user intent score.

### BRIEF DESCRIPTION OF THE DRAWINGS

FIG. 1 illustrates an example diagram of a product market measuring system including related inputs;

FIG. 2 illustrates an example of a product market;

FIG. 3 illustrates an example of identifying competing keywords;

FIG. 4 illustrates an example of identifying competing keywords where competing items are not known;

FIG. 5 illustrates an example of creating a network of content relevant to an item's product market;

FIG. 6 illustrates an example of scoring a network of content based on search terms used by users to find web content;

FIG. 7 illustrates an example of creating a network of content based on user characteristics;

FIG. 8 illustrates a first example method embodiment;

FIG. 9 illustrates a second example method embodiment; and

FIG. 10 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Marketers need to identify and market to people who are both interested in their specific items (such as products or services) and have (to varying degrees) an intention to purchase it. While some marketers, such as those haggling at a fair, may be able to visually measure a potential customer's intent, with online commerce determining the amount of intent a potential customer has becomes a technical problem. More specifically, because the online customers communicate with the vendors, marketers, distributors, etc., via the Internet, interpreting the level of intent of potential online customers must be done using inputs (also known as “intent signals”) provided (or revealed) by those potential customers. Intent signals can be any information provided by a user (indirectly or directly) during online behaviors. For example, intent signals can include communications or behavior made directly by a user, which in most computing circumstances can include the user's search terms (including the vocabulary used, the order of the words) and which items, products, or links are selected by the user (e.g., which of the presented search results did the user click on), and/or information about items or products downloaded/consumed by the user. Measuring a potential customer's intent signals includes solving at least two high-level problems: (1) identifying what types of user engagement are a potential indication of purchase intent; and (2) measuring the level of that purchase intent.

Previous attempts to solve the problem of measuring a potential customer's intent signals have various limitations. Non-limiting, exemplary limitations of those previous attempts include: (A) Use of generic intent categories common to all sellers, such that the solutions are generic in how they associate an area of interest revealed by a user's engagement with content online by tying user intent to a common taxonomy of topics that is applied to all sellers. In the instances when the “common” taxonomy does not adequately describe the product or service of an individual seller, the taxonomy requires a modification to expand its discretionary coverage that is not performed automatically. (B) Use of static intent categories, such that they rely on a static categorization of intent that changes only periodically, when the topic taxonomy underpinning it is updated, rather than incorporating more continuous changes in how users regard their set of product options to consider for a given purchase. (C) Are a referred site based on what the users view (e.g., the user watched a video on a topic, so the system will show her similar video options), not the words affirmatively communicated by the users when accessing the referred webpage to convey the user's intent.

These approaches are limited because they do not necessarily capture the nuances of what a prospective buyer is looking for, or the specific set of products that would be reasonably interchangeable in serving their need.

By contrast, systems and methods configured as disclosed herein can define the addressable market through user expressions of intent. The systems and methods configured as disclosed herein can use the specific search terms of a user to identify for specific items (which may or may not include products, services, or other types of data) as “intent signals” indicating the item for which the user was searching. That is, the words used by the user to search for a product can be used to predict the level of the user's intent in buying, using, or otherwise engaging with a particular item. These words/intent signals used by the user to search for an item can be linked to all known items which have a similar purpose. Collectively, the searched—for item and its alternatives that are reasonably interchangeable for a similar purpose represent the “product market” tied to the user's intent. In this manner, the system can build a list of keywords used by users to search for a group of interchangeable items, and can predict (based on which of those keywords a subsequent user uses, the order in which the words are presented, and/or if the user bought the product or interacted with the item) a level of intent of a subsequent user (which may or may not be the same subsequent user identified above).

Consider the following example. Several online vendors are selling several black markers (that is, black felt-tip pens with a broad tip). The system first identifies that these items (the different types of black markers) are interchangeable with one another. interchangeable items can be identified through any method known to those of skill in the art. Non-limiting examples of such methods can include: (1) Manual inputs provided by a marketer, where the marketer provides a list of competitor company domain addresses, which indicate to the system directly (e.g., a marketer lists the domains they consider to be their competitors and the system accepts those domains as being for products that are interchangeable) and through extrapolation that the items sold through those domains are substitutable; and (2) Systematic discovery, where a user/customer defines their product (e.g., by providing URLs (Uniform Resource Locator) for their product pages) and possibly product content. The system can then identify keywords used to find that product. Next, the system can find products with similar content, keywords, user demographics, etc., to define the set of substitute products that are part of the customer product's “product market.”

For example, when the user gives their domain address (domain A), the system might identify (1) the search keywords used by other users to access domain A; (2) the keywords found within the content of web pages on domain A; and (3) the most frequently observed title and role among users who visit domain A. While a user may prefer one brand over another, from a functionality perspective all the available black, felt-tip markers are interchangeable with one another. Next, the system collects the terms users use when searching for black markers. For example, one user may search for “big black pen,” another for “dark marker,” and yet another for “best permanent marker.” For each of these searches, the system can record interactions and based on those interactions the system can then determine which of the words used by the user indicated true intent in a black marker. Please note that the system described herein, which describes and measures a user's intent, does not depend on having purchase data. While linking purchase data to the keywords can be a factor in the scoring of those keywords, purchase data is not required to do this. When subsequent users search for a black marker, the system can then analyze their subsequent search terms and determine a level of intent of the subsequent users based on the words they used in their search. The list of words used by users to search for any item in a list of interchangeable items can be considered “keywords,” and may further include weights of the words regarding user intent to purchase or otherwise engage with an item (e.g., subscribe to a service, rent the item, select the item from a database).

By using the ongoing stream of search terms of users, rather than relying on conventional product categories, the system can identify keywords from users which describe and clarify the set of products that are reasonably interchangeable for a similar purpose, including those nominally expected to be interchangeable but are not actually interchangeable, and those not expected to be interchangeable and actually are interchangeable.

In some configurations systems configured as disclosed herein can identify lists of interchangeable items by scraping the Internet. For example, if the user is searching for a substitutable product, the system can search/query the database for information (e.g., content, keywords, user demographics, etc.) contained within the list of substitutable products or metadata associated with those products. Based on that information and/or metadata, the system can generate a list of keywords which can be used by the system to evaluate a user's intent in the substitutable products. Likewise, for users searching for a product or service, the system can scrape multiple websites, identify keywords associated with similar products/services, and calculate which searched words correspond to the user's intent. While purchase data and other sales information may, in some configurations, be useful to score the user's intent, it is not required. The system may scrape an entire website and then match common words from similar products. The system may also crawl websites and identify keywords without scraping all of the content from those websites, and the keywords may be derived from search data without any data on the destination websites following from those searches. In addition, the system can make use of services, websites, or other algorithms which can take an item's metadata (e.g., a product's webpage) and rank the keywords used to arrive at that item (e.g., the search terms users use to arrive at the product's webpage, or the words used to search for a particular piece of information). In some cases, there may be an item (e.g., data, product, service, etc.) which is suitable to the user's needs and that may be both a subset of all options within a list of items and cut across multiple item categories.

The system can also correlate the keywords with data about the users—such as (but not limited to) demographic data, location data, job title, roles, etc. This user information may come from multiple sources. Two non-limiting examples are: (1) Web tags, where web “tags” placed on the website(s) visited by the user can capture cookie-level and IP-level user data. (2) User browser extensions, where browser search extensions track user-level metrics including job title and user-level search terms (e.g., a user adds a CHROME (or other Internet browser) extension which tracks the search terms of that user across the web and user-level demographics). As part of that process the system can, for example, access Internet cookies, viewing history, or other internet metadata regarding the user's browsing history. For example, returning to the marker example, when a person with a first job title (for which the purchase of markers is generally part of job responsibility) searches for “dark permanent marker,” it may indicate that the user has a high level of intent to purchase a black marker, whereas if a different user with a second job title (for which the purchase of markers is not generally part of job responsibility) described the item as “dark permanent marker,” (i.e., the same search terms), it may not indicate that the second user has a high level of intent. Likewise, the system may identify keywords which are used to describe an item, where the keywords vary by region. In such cases, the predicted level of intent may depend more on other demographic data than keywords (e.g., the weight of the user's location data may change how the system values the keywords detected).

Data collected by the system can be transformed into a graph model, with nodes representing items and keywords for a user, demographic, entity, etc., and edges weighted based on the relationship of the user/demographic/entity, etc. to the keywords. Impressions can be mapped to keywords, accounts, and contacts, among other types of data.

When the system calculates the level of intent, preferably that level of intent is a percentage indicating a likelihood of purchase (or that the item is the desired item) based on the keywords used (in combination with demographic or other information about the user). For example, the user may have a 65% (or other computed value) likelihood of making a purchase, engaging in a service, etc. Purchasing intent can be determined by a number of factors, including, for example, (1) the relevance of the referral terms used and content visited, (2) the level of visitation (e.g., how often the user used these search terms before visiting these websites), and (3) the amount and type of content downloaded (e.g., number of PDFs downloaded and the relevance of that content to a purchase decision).

As an example of (1) “the relevance of the referral terms used and content visited,” consider two websites:
Website 1 (a website related to a customer's product), where the top-3 most common search terms (by frequency) are:
Marker (5 instances)
Black (3 instances)
Pen (2 instances)

Website 2 (any website in the network of websites for which the product can access visitation data), where the top-3 most common search terms (by frequency) are:
Marker (4 instances)
Pen (2 instances)
Other (1 instance)

In this example, the system can use a variety of methods to rank similarities between website 1 and website 2, including co-occurrence and correlations. From this correlation, the system can determine that website 2 is, for example, 80% related to the customer's product.

As an example of (2), “the level of visitation,” the system can identify relative (i.e., indexed) changes in a user's visitation history. For example, the system may determine that a user visited website 2 once in a first period of time and five times in a second period of time, suggesting a surge in their level of interest in the product market.

The system's calculated level of intent of a user can be a “user intent score”. The user intent score can be expressed as a vector (i.e., a numerical and/or mathematical representation of the user's intent), as a letter grade (i.e., A, B, C, D, E, and F, with A being an excellent grade and F indicating a failing grade), or any other ordinal representation. Preferably, the system presents the level of intent as an “intent vector,” where the calculated intent score has been transformed into a mathematical and/or numerical representation.

Once the system calculates a predicted level of intent of the user, the system can present that predicted level of intent to one or more entities for marketing, advertising, or otherwise persuading the user to interact with a given item. For example, if a user is extremely unlikely to purchase a product (e.g., intent is less than 10%), the marketer might not spend a large amount of resources trying to convince someone who is unlikely to become convinced. However, if the user has a reasonable level of intent (e.g., 50%), the marketer may spend more resources to try and convince the user to make the purchase, engage with the service, etc. And if a user is extremely likely to purchase a product (e.g., intent is greater than 90%), the marketer may focus their resources on convincing the user to buy their specific product over others in the same product market.

In some cases, the marketer may adjust what item is presented to the user based on their level of intent. If, for example, the user is predicted to be very likely to make a purchase, the marketer may present the most expensive option, whereas is the user is undecided the marketer may present a more affordable option. Likewise, the marketer may use different channels of communications depending on the predicted user level of intent. Non-limiting, exemplary communication channels marketers can use can include: displays (e.g., for advertising), search (e.g., displaying advertisements concurrently with search results), social media, emails, phone calls, events (both live and/or virtual), etc. For example, if the predicted level of intent reaches a first predetermined threshold, the system may seek to display an advertisement, whereas at a higher, second predetermined threshold compared to the first predetermined threshold the system may initiate an email or contact a representative to make a phone call to the user.

In some configurations, the system can generate a level of intent for users from a common organization. For example, if there are multiple individuals which all work for a company “A”, the system can group those individuals together and generate a common level of intent for the entire group, and can market or otherwise adjust offering to the group based on the common level of intent. The common level of intent can, in some configurations, be an average of the different levels of intent predicted by the system for the different users within the group for a common item. That is, if users X and Y within company A both searched for an item Z and had respective levels of intent predicted by the system, the predicted level of intent for company A with respect to item Z could be an average of the levels of X and Y. In other configurations, the common level of intent may be based on the level of usage of X and Y, such that if X uses the system more than Y, the system will weight X and Y based on that usage, with the level of intent of X being more dominant. In yet other configurations, the common level of intent can be spread across multiple items, such that the predicted level of intent for the group is based on all searches X and Y have previously made, or searches X and Y have made within a predetermined amount of time. Identifying the users who belong to the common organization can be based on information obtained from an entity's records within a CRM (Customer Relations Management) database. Likewise, identification can be based on location information, titles, roles, demographic data, and/or any other information which can convey a common organization.

In some configurations, the system can identify content elements associated with items in a list of items, then use those content elements to generate the user's intent score. For example, in such configurations, the system can generate a content embedding linking the content with the content's relevancy to one or more items in the list of items. An embedding is a relatively low-dimensional space into which you can translate high-dimensional vectors. Embeddings make it easier to do machine learning on large inputs like sparse vectors representing words. Ideally, an embedding captures some of the semantics of the input by placing semantically similar inputs close together in the embedding space. An embedding can be learned and reused across models. In this case, the system can generate an embedding (i.e., a vector of continuous numbers), where the values of the embedding reflect the content's relevance. The embedding can also be a tensor (i.e., an algebraic object that describes a multilinear relationship between sets of algebraic objects related to a vector space). The system can then use the content embedding(s) to identify the relevancy of website content and the user's intent.

The embeddings/vectors can be generated using, for example, a natural language processing encoder such as, but not limited to, WORD2VEC. The content in question can be any type of content including, but not limited to: text, images, audio content, multi-language content, etc. The embeddings can, for example, be used to automatically calculate the relevancy of the content to one or more items in the list based on distance measurements between embeddings (using, for example, cosine distance or other distance measurements). In addition, the relevancy for content can be used for content in multiple languages. The relevancy of website content to item content can be determined, for example, by a score, where the users can be associated with an organization and an intent vector for the organization can be determined based on the intent vector of the users associated with the organization.

In addition, the system can identify what website(s) a user has visited by having/receiving a list of web addresses accessed visited by the user, then comparing those web addresses against a list of known web addresses associated with websites. In other configurations, the system may query an Internet domain name registry service or other third party source to identify the website visited by a user.

Technological improvements associated with systems configured as disclosed herein include generation of a constantly evolving “map” of how users search for given items, with that map corresponding to a user's level of intent by user-communicated signals—namely the search terms that lead them to content about the item. Moreover, because the system can capture search terms from multiple users, the system can generate a prediction of the user's level intent without the user having used the system previously (based on the search terms, demographics, metadata, and conclusion (e.g., purchase, affirmation) of previous users). Likewise, the users whose interest in a product market is identified and measured do not have to be among the users whose search behavior was originally used to identify the content and keywords that define the product market-though data is still required of a user to be able to identify and measure their intent.

Next, please consider the non-limiting examples illustrated in the Figures.

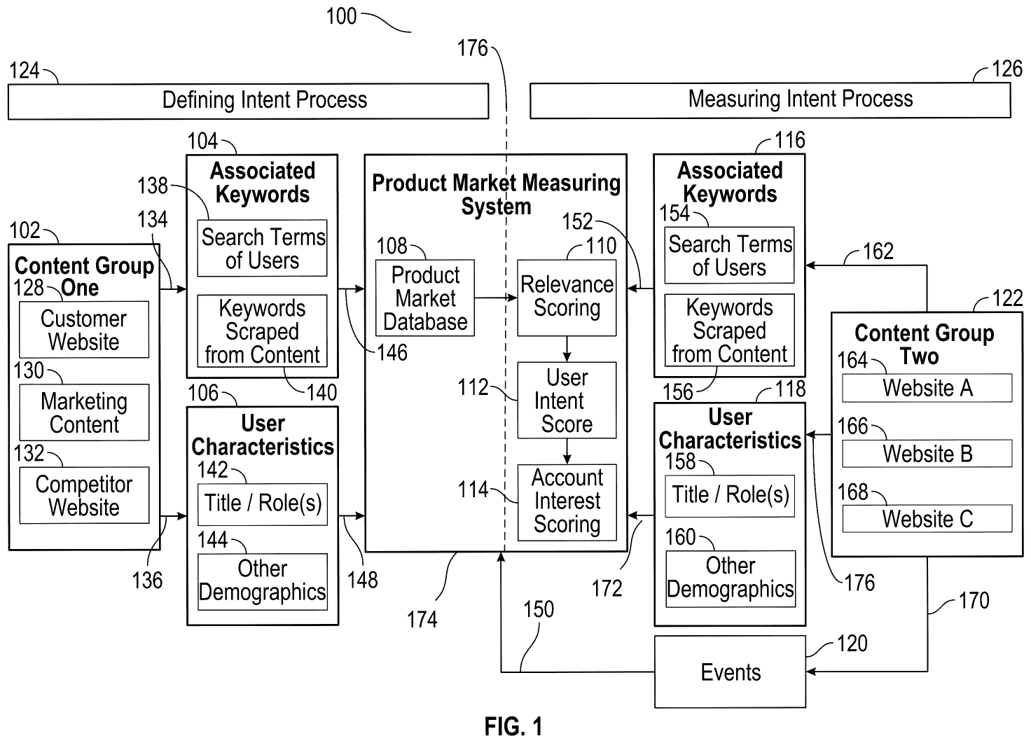

FIG. 1 illustrates an example system diagram, with the system generally shown at 100, for defining an addressable market through user expressions of intent. System 100 generally includes a product market measuring system 174 that receives different types of inputs 146, 148, 150, 152, 172 based on processes relating to and including more, less and/or any combination of: first associated keywords 104, user characteristics 106, content group one 102, second associated keywords 116, user characteristics 118, content group two 122 and/or events 120, for example, as shown. In other examples, the product market measuring system 174 can be applied to other items beyond products (such as data, services, etc.). As discussed in more detail below, these inputs 146, 148, 152, 172, 150, for example, can be used by the product market measuring system 174 to generate user intent score 112 and, if there are multiple users from a common organization or common entity, to generate an account intent score 114 for that common organization.

System 100 is shown referring to part of system 100 as a defining intent process 124 and a part of system 100 as a measuring intent process 126. Dashed line 176 is shown as an exemplary division of system 100 according to defining intent process 124 and measuring intent process 126. The defining intent process 124 and the measuring intent process 126 can refer to the separate processes for collecting data from users and the words they use to search for products to define intent (i.e., the defining intent process 124) and for collecting data to measure a current user's intent (i.e., the measuring intent process 126). The defining intent process 124 identifies characteristics (e.g., keywords) that that will then enable the measuring intent process 126 to identify users/organizations with intent and their level of intent. In this manner the defining intent process 124 is about establishing criteria, not finding prospective buyers.

In some configurations the defining intent process 124 and the measuring intent process 126 can use common data sources, whereas in other configurations (such as the one illustrated) the defining intent process 124 and the measuring intent process 126 can utilize separate data sources (e.g., content group one 102 and content group two 122) or use the same data sources but be separate instances (e.g., access the resources at different times using separate computing processes). Preferably, content group one 102 is a subset of content group two 122. In such configurations, content group one 102 can be a targeted set of content that best describes the products comprising the product market. Content group two 122 and the second associated keywords 116 are then associated with website traffic across a much larger set of websites in which the system looks for users/accounts associated with those second associated keywords 116. Differences between the defining intent process 124 and the measuring intent process 126 can include: (A) The number of URLs used to define the product market in the defining intent process 124 are likely to be fewer than the number of URLs used to identify and measure users with intent in the measuring intent process 126. (B) Whether the content is associated directly with the product (e.g., a product webpage about the customer's product vs. a business website article about technology trends that apply to the product's product market).

Beginning with the defining intent process 124, the product market measuring system 174 identifies one or more elements of content group one 102 relevant to a product (e.g., a customer website 128, marketing content 130, a competitor website 132, other URLs for websites relevant to the product, documentation for the product, and/or marketing collateral for the product). The product market measuring system 174 can initiate scraping of customer website 128, competitor website 132 or other content sources related to content group one 102, and use 134 the content group one 102 to identify first associated keywords 104 associated with content group one 102. Preferably, these first associated keywords 104 are obtained using the search terms of users 138. The first associated keywords 104 can be defined after techniques are employed: (1) to distill various keywords to their common roots (e.g., “lemmatization” or a less involved version of it called “stemming”) (e.g., “running,” “run”, “ran”, are also bundled under, for example, “run”) and (2) removing generic or “stop words” that are not descriptively important (e.g., the, it, etc.). The first associated keywords 104 can also be keywords scraped from content 140. In other cases, the first associated keywords 104 can be identified by tracking the search terms used by contributary network of users when they access content from content group one 102. For a contributory network to operate, the users can place an extension on their Internet browser, which then shares their page visits and referring keywords with the system, with those referring keywords becoming the first associated keywords 104. Another method to identify the first associated keywords 104 can be through back-link extrapolation, where web scraper algorithms identify the websites that are most likely to return on search engine searches for certain keywords and extrapolate the highest rated keywords for those websites. This is commonly referred to as backlink data.

The product market measuring system 174 can also initiate 136 identifying user characteristics 106 of the users who are engaging with content group one 102. Examples of the user characteristics 106 can include the user's title/role(s) 142, as well as other demographics 144 such as, but not limited to age, education, location, etc. In some cases, the user characteristics 106 can be determined using referral traffic analytics, where the system uses IP (Internet Protocol) data or cookie data based on the users Internet usage, and this data can be used to partially identify the users. Such data can be augmented by mapping the data to demographic information for that IP/cookie. In addition, the system can learn user characteristics 106 using information provided directly by the user, and can also add information to products regarding role titles and other demographic characteristic that have been identified as associated with a product's typical buyers.

Regarding the measuring intent process 126, the product market measuring system 174 can identify additional sources of content, content group two 122, which are measurable. For example, the product marketing system can identify the relevance of a group of websites to a product market and from which user impression data on the websites can be measured. As shown in FIG. 1 the websites may include website A 164, website B 166 and/or website C 168. The “product market” is defined by the data (e.g., content keywords, search terms, user characteristics) that are associated to a group of reasonably interchangeable products and/or services. The relevance of each website A 164, website B 166 and/or website C 168 to the product market can be determined, for example, by (1) search terms of users referred to the website, (2) content keywords, and/or (3) characteristics of the users. Exemplary relationships/sources which can be used to track this data can include: information that the users provide, the user's own web data, third-parties that have agreed to enable the sharing of relevant data (e.g., through the placement of a “tag” on their website), and/or third-party websites through which the system has identified/known search terms by users who have agreed to share their search term data.

The product market measuring system 174 can initiate 162 identification of second associated keywords 116 associated with content group two 122 in a manner similar to identifying the first associated keywords 104 within the defining intent process 124, as described above, with search terms of users 154 and keywords scraped from content 156 found in content group two 122. The resulting second associated keywords 116 of the measuring intent process 126 may be the same or different keywords than the first associated keywords 104 identified during the defining intent process 124. While the first associated keywords 104 and second associated keywords 116 may not necessarily be the same, it would be very unlikely, if not impossible, for them to be entirely different.

The product market measuring system 174 can also initiate the identification of user characteristics 118 (such as title/role 158, or other demographics 160) for users within the measuring intent process 126 in a manner similar to the identification of user characteristics 106 under the defining intent process 124, as described above.

The product market measuring system 174 can also initiate identification of events 120. Events 120 can include, for example: IP addresses of users who engage with the website A 164, website B 166 and/or website C 168, cookie-level data of users, a log mapping a specific source to a user, duration of visits to each website A 164, website B 166 and/or website C 168, etc. The events 120 can also track a total engagement time, or usage time, of a user with content group two 122. To capture the user level impression data tied to a particular website A 164, website B 166 and/or website C 168, the product market measuring system 174 can use website tags, where the tags are located in the content or webpages of the website A 164, website B 166 and/or website C 168, and the tags can include instructions which cause computing devices to monitor and capture the network session events generated by the computing devices, and to send the captured network session events to the product market measuring system 174.

With the data collected, the product market measuring system 174 can build a product market database 108. More specifically, the product market measuring system 174 can initiate scoring of the first associated keywords 104 and/or user characteristics 106 associated with content group one 102 for their strength in indicating the probabilistic likelihood that the user is interested in participating in the client's product market. The keyword scoring can be based on multiple factors including, but not limited to:
Search-derived, frequency: The total number of times that users used an associated keyword from the first associated keywords 104 to find any piece of content in content group one 102.
Search-derived, commonality: The frequency by which any one associated keyword from first associated keywords 104 was used across multiple pieces of content in content group one 102. (i.e., considering whether a keyword was consistently used across all sources in content group one).
Content-derived, frequency: A frequency of presence of a keyword in the first associated keywords 104 in all of content group one 102.
Content-derived, commonality: Share of sources in content group one 102 in which a keyword within the first associated keywords 104 was present (if at all).

The product market measuring system 174 can also initiate, through inputs 148, scoring of the user characteristics 106, where the user characteristics 106 scoring can be based on multiple factors including, but not limited to:
Frequency of visits to content within content group one 102 (in total): The frequency with which a given demographic trait is associated with a user who visits the content in content group one 102.
Frequency of visits to content within content group one 102 using top-ranked keywords: The frequency with which a given trait is associated with a user who uses the top-ranked keywords to visit the content of content group one 102.

The product market measuring system 174 can then perform relevance scoring 110 for each source for which engagement is measurable, based on mapping the first associated keywords 104 and user characteristics 106 associated with a product market to the second associated keywords 116 and user characteristics 118 associated with the content for which engagement is measurable. In other words, the relevance scoring 110 combines information gathered from both the defining intent process 124 and the measuring intent process 126. The objective of the relevance score 110 is to score the relevancy of websites in content group two 122, based on how relevant a given website A 164, website B 166, website C 168 is to the product market. This score can account for several factors including:
Similarity in the search terms, content keywords, and user characteristics across those in the product market, website A 164, website B 166, and website C 168, adjusted for how relevant a variable is to the product market. For example, if the word “ESG” is deemed to be 90/100 relevant to the product market and the work “consulting” is 10/100. If both words are present at an equal frequency across the website A 164, website B 166, and website C 168, the term “ESG” should be held as a higher indicator of relevance than “consulting”.

The similarity of terms can be adjusted for the type of variable. For example, if search terms are determined to be better at determining the relevancy of website A 164, website B 166 and/or website C 168 in comparison to user characteristics 106, 118, similarities in search terms should be weighted higher in comparison to similarities in user characteristics 106, 118. There are several methods that score these relationships that the product market measuring system 174 might employ. For example, the product market measuring system 174 can calculate and compare the percentage of traffic on a target website A 164, website B 166 and/or website C 168 that is due to the second associated keywords 116 identified in the product market, and then weight that traffic according to the relevancy of each keyword in the second associated keywords 116.

The product market measuring system 174 can then generate a user intent score 112. The objective of generating a user intent score 112 is to develop a score for identified IP addresses that rates user engagement with sources relevant to the product market. This scoring system can account for several variables including:
Frequency of engagement across the entire portfolio of content group one 102 and content group two 122 that meet the threshold for relevance.
Frequency of engagement with content in content group one 102 and content group two 122 that are deemed most relevant to the product market. (i.e., if user 1 has visited two sources with relevancy scores of 80% and 80%, and user 2 has visited two sources with relevancy scores of 95% and 80%, then holding all else equal user 2 should receive a higher score.)
Timeframe of engagement. The product market measuring system 174 can prioritize the recency of engagement.
Duration of engagement. When data is available regarding on how long (time) a user spent on a source, this can be a prioritized holding all other variables equal.

This generating of a user intent score 112 can measure intent relative to a baseline, not simply “gross” intent. For example, holding all other variables not mentioned equal, if user 1 has visited a website five times per month across three consecutive months (Oct, Nov, Dec), and user 2 has visited that same website one time per month in Oct and Nov, but in Dec visited it four times, an account for the relative change in intent should be incorporated into the score.

If there is a group of users which have a commonality, or otherwise belong to a common account, the product market measuring system 174 can generate an account intent score 114. The objective of generating an account intent score 114 is to identify any subsegments of users who are associated with a particular domain address and/or account, and develop an account intent score based on the associated user intent scores.

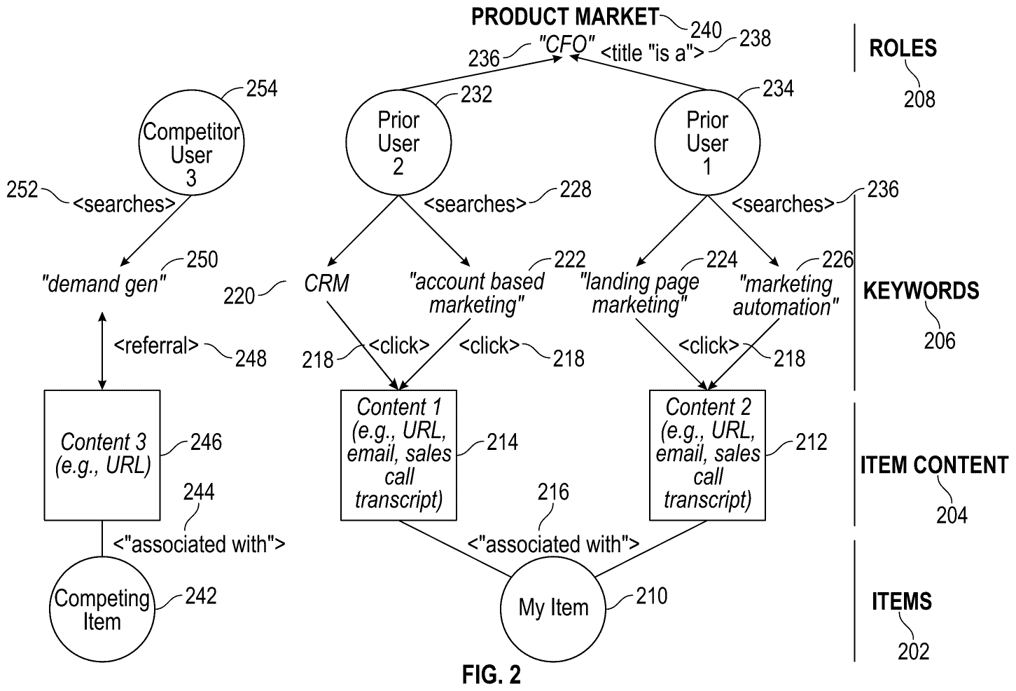

FIG. 2 illustrates an example of a product market 240. Within the product market 240 are items 202 (i.e., a product or a service), item content 204 (e.g., labels and URLs about the items 202), keywords 206, and roles 208 of users who make or influence purchase decisions. The keywords 206 can be used to find item content 204 (i.e., searched for in finding “Item Content” 204 URLs) and/or used to describe items 202 in content URLs (i.e., contained in “Item Content” 204 URLs).

Considering the specific example illustrated, “My item” 210 can be any product. For example, “My item” 210 could be a customer's product, it could be a service used by a user of the system. “My item” is associated with 216 (or otherwise linked) to one or more instances of item content 204, typically a URL. As an example, Content 1 214 can be a landing page for “My item” 210 with a URL tied to that landing page. Content 2 212 can be another web page which lists the services provided a company's website. Both webpages (i.e., Content 1 214 and Content 2 212) are associated with 216 “My item” 210″. In this manner, “My item” 210″ is linked to one or more web pages or other types of item content 204. The associations 216 can be made by the customer or other user, tying a URL to a product or service.

The websites (i.e., Content 1 214, Content 2 212, or any other types of item content 204) are related to keywords 206. The keywords 206 are the search terms that users, prior users, or any other users can use to get to the URLs associated with Content 1 214, Content 2 212, or any other types of item content 204. So, in this illustrated example, the keywords 206 include: “marketing automation” 226, “landing page marketing” 224, “account based marketing” 222, and CRM (Customer Relationship Management, e.g., a software system that helps business owners easily track all communications and develop relationships with their clients and leads) 220. Each of the keywords 206 are tied to the websites (i.e., Content 1 214, Content 2 212, or any other types of item content 204), meaning that as prior users 234, 232 executed searches 228, 236 which included the keywords 206, and clicked 218 on results, they were directed to the websites (i.e., Content 1 214, Content 2 212, or any other types of item content 204), and ultimately “My item” 210.

Each user 232, 234 can have role 208 information, such as user characteristics, job titles, demographic data, etc., linked with the user 232, 234. In some configurations, the system can capture cookie-level information as the user 232, 234 browses, and the system can associate a user and that user's IP (Internet Protocol) address to the role (e.g., “CFO” 236 or any other title or role).

While the system is aware of “My item” 210, a user can inform the system that there is a competing product, “Competing item” 242″, and inform the system of item content 204 (e.g., Content 3 246) associated with 244 the “Competing item” 242. Based on that information, the system can identify what keywords 206 (e.g., “demand gen” 250) were used to refer 248 users to the Content 3 246 item content 204 when the competitor user 254 conducted searches 252 for the competing item 242.

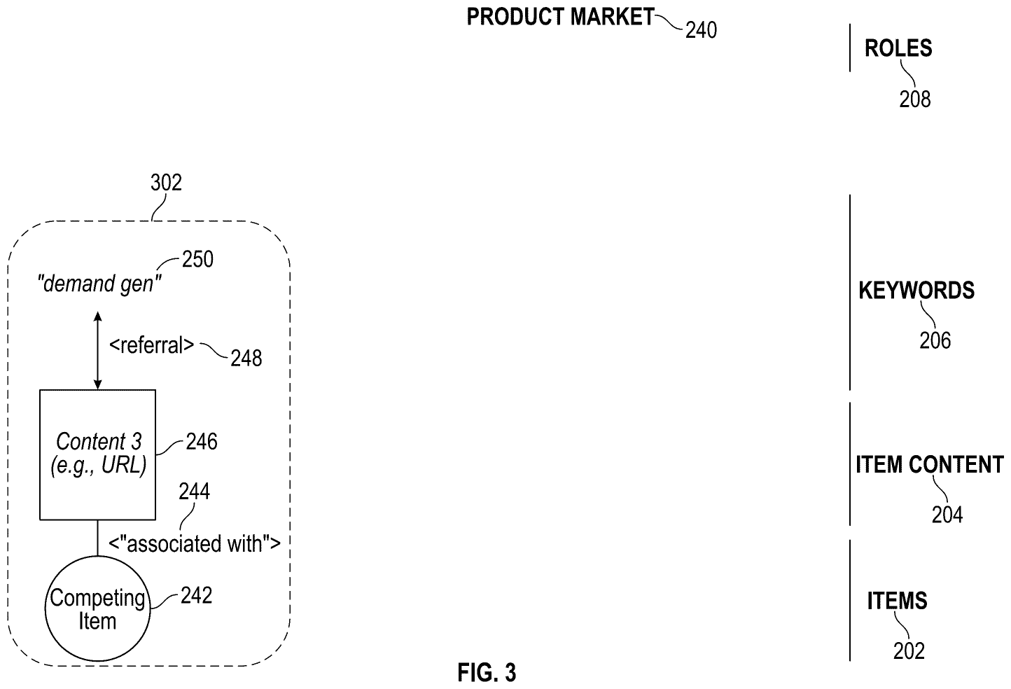

FIG. 3 illustrates an example of identifying competing keywords, focusing on just the competitor item portion 302 (i.e., the competing item 242, Content 3 246, and the keywords (e.g., “demand gen” 250). As stated above, a user of the system can enumerate a list of one or more URLs for webpages about competing items, resulting in Content 3 246, and the system can identify keywords searched for by prior users who visited the URLs within Content 3 246.

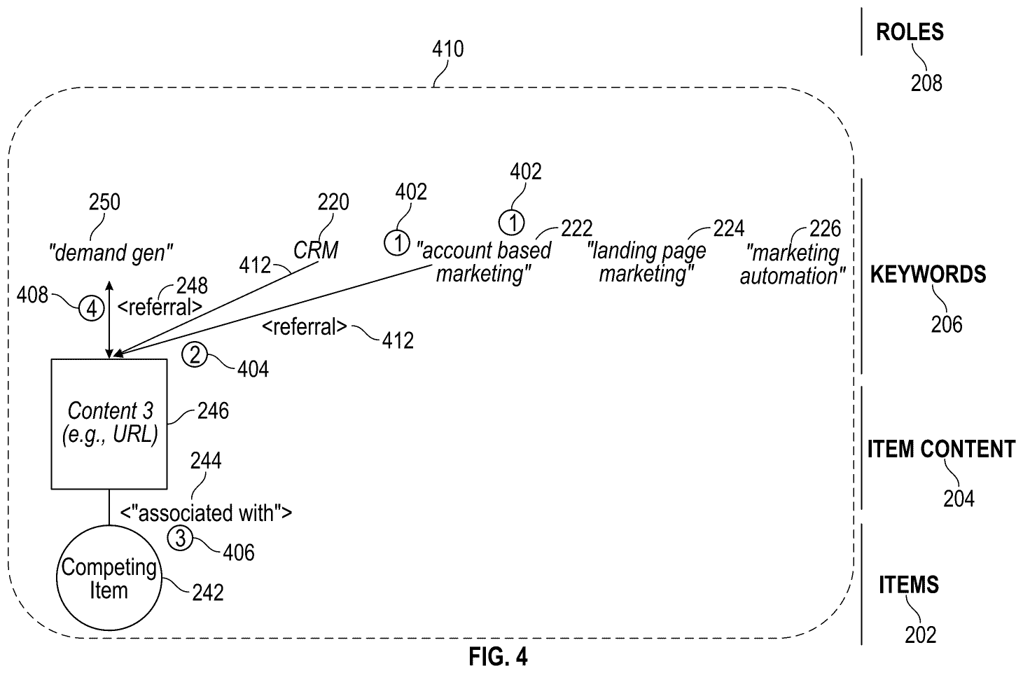

FIG. 4 illustrates an example of identifying competing keywords where competing items are not known (e.g., when the competitor item portion 302 in FIG. 3 has not been provided by a user). The competitor item portion 410 includes the keywords 220, 222, 224, 226 previously identified. In this example, because no user has provided any information related to a competitor or competitor items, the system will find and identify such information. To do so, the system will first (item #1) 402 build a set of weighted keywords for the item of interest (i.e., the competing item 242). The list of the keywords can, for example, come from a marketer's website traffic. The system can then (item #2) 404 identify other competing websites (e.g., Content 3 246) with similar clusters of keywords used by users to access the competing websites. For example, the system can use the keywords 220, 222, 224, 226 associated with “My item” 210, and will find other websites (e.g., Content 3 246 in this example) sites that refer 412 (i.e., are associated with) to those same keywords 220, 222. As illustrated, keywords CRM 220 and “account based marketing” 222 refer 412 to Content 3 246, while “landing page marketing” 224 and “marketing automation” 226 do not. In some configurations, the system can (item #3) 406 gather user input for which websites should qualify as a competing item website, or as competing item content. The system can also (item #4) 408 identify other keywords, such as “demand gen” 250 which refer 248 to Content 3 246.

The system can also rank keywords associated with Content 3 246. For example, based on the frequency of search terms which are used to arrive at Content 3 246, “account based marketing” 222 might be the least commonly used keyword, while “demand gen” 250 might be the most frequently used keyword. In such case, because “demand gen” 250 is a relevant keyword, the system can refer 248 (i.e., generate a referral) linking the “demand gen” 250 to Content 3 246. The system can also record Content 3 246 as explicitly linked to the competing item 242, but regardless the system will have expanded the list of keywords that are relevant to “My item” 210 by using these referrals.

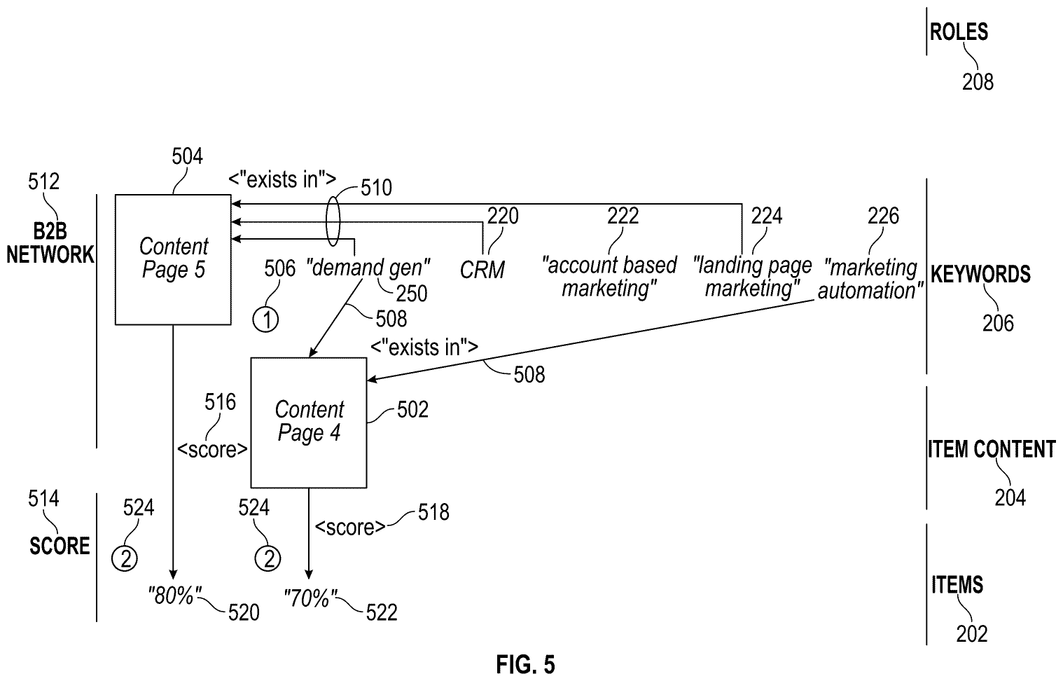

FIG. 5 illustrates an example of creating a network of content relevant to an item's product market. In this example, the keywords 206 include “demand gen” 250 because it is tied to the URL or other content of a competing item, resulting in five keywords (“demand gen” 250, CRM 220, “account based marketing” 222, “landing page marketing” 224, and “marketing automation” 226) that are relevant to the product market 240. In this example, the system can (item #1) 506 find content that contains one or more of the keywords 206.

As illustrated, the system has identified two pieces of content: Content Page 4 502 and Content Page 5 504. As illustrated, the system has identified that keywords “demand gen” 250 and “marketing automation” 226 exist in 508 Content Page 4 502, and that keywords “demand gen” 250, CRM 220, and “landing page marketing” 224 exist in 510 Content Page 5 504. Content Page 4 502, and Content Page 5 504, are not part of the system, but are instead managed by third parties, and are thus part of a B2B (Business-to-Business) Network 512. Next, the system can (item #2) 524 score 514 the newly discovered content (Content Page 4 502, Content Page 5 504) for fit based on the product market 240 keywords 206. This scoring can, for example, be based on relevancy to the product market 240. For example, the scoring 516, 518 may depend on frequency that the words are used, the score of those words themselves, etc. The system can then generate a score 520 to Content Page 5 504 and a score 522 to Content Page 4 based on the relevancy of the respective content to the product market 240 by identifying how frequently the keywords 206 appear in the newly discovered content (Content Page 5 502 and Content Page 4 504).

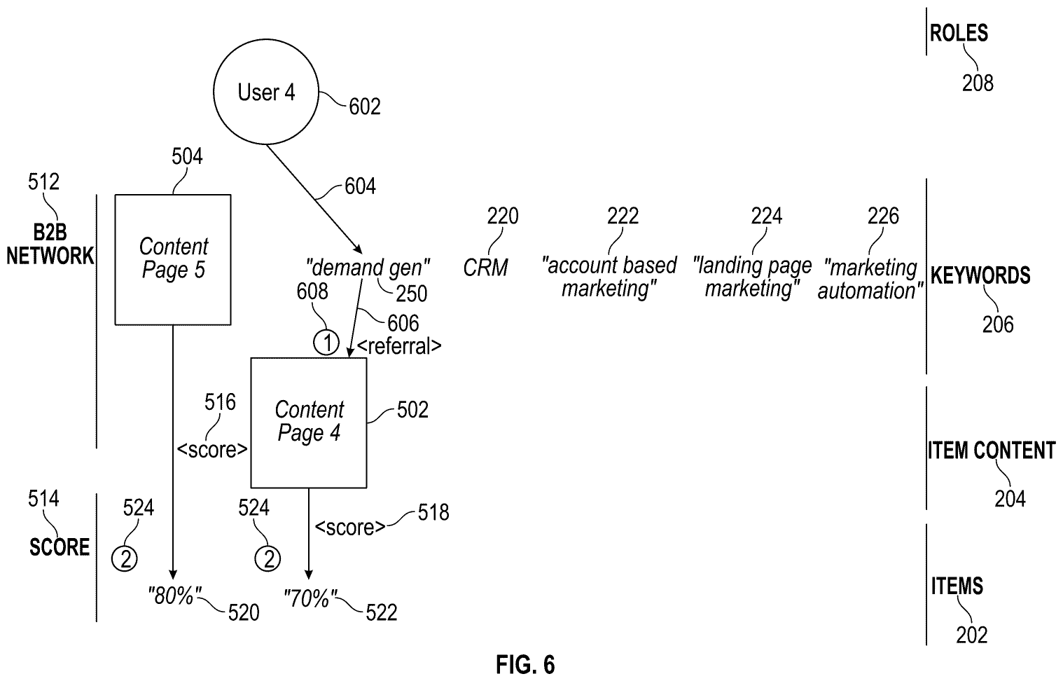

FIG. 6 illustrates an alternative example (to the method illustrated in FIG. 5) of scoring a network of content based on search terms used by users to find web content. In this example, a user (User 4) 602 has made a search 604 using “demand gen” 250, and has found (item #1) 608 or otherwise been referred 606 to Content Page 4 502 using “demand gen” 250. Based on the relevancy process shown above in FIG. 4, the system already knows that “demand gen” 250 is relevant to “My item” 210 and is a keyword 206 within the product market 240. The system can then (item #2) 524 score the Content pages 502, 504 based on frequency and/or whether a user 602 searched that keyword to reach a page. The scoring (item #2) 524 can result in raking of the additional content 502, 504 by frequency and/or by importance. It is noted that the importance of the keyword is not determined by how frequently a user searches the term to arrive at “Content Page 4” 502 but rather it is based on how frequently the keyword is used to get to Content 1 214 and Content 2 212. This frequency will determine the score of “Content Page 4” 502. (For example, the “Demand Gen” 250 may be the 100th most used keyword to get to “Content Page 4” 502, but this should not impact its relevance of the keyword. Other measures of keyword importance can include: (1) Correlation of a search keyword to payment; and/or (2) Timing that the keyword was used.

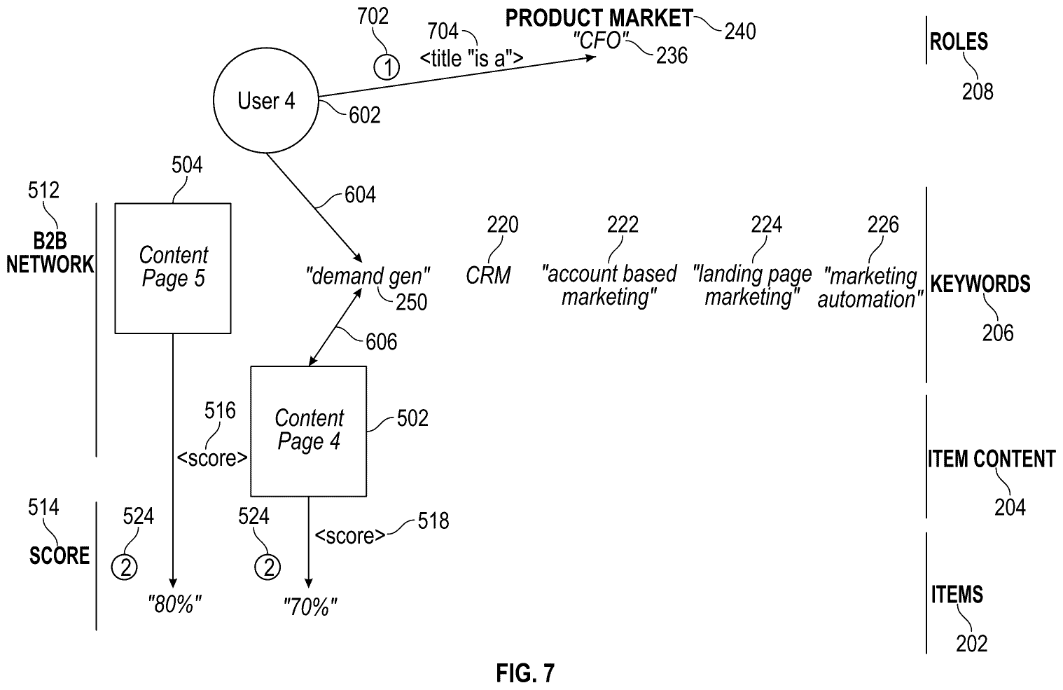

FIG. 7 illustrates an example of creating a network of content based on user characteristics. Whereas in FIG. 5 the relevancy (i.e., scoring 524) of additional content 502, 504 can be based on relevant keywords within the content, and in FIG. 6 the relevancy of the additional content 502, 504 can be based on relevant keywords searched for to find the content 502, 504, in this example the relevant data used to score 524 the additional content 502, 504 are titles, roles 208, or other user characteristics of the user 602 who made the search 604. Item #1 702 allows the system to identify similarities in the demographics (e.g., roles) of users who click on those pages, content, etc. For example, if the system has identified that three users have visited a website (e.g., Content Page 4 502), and all of them have “CFO” 236 as their title 704, the system can identify that title/role as a relevant title, and the system can score the content page (Content Page 4 502) within the B2B Network 512 based on that role/title.

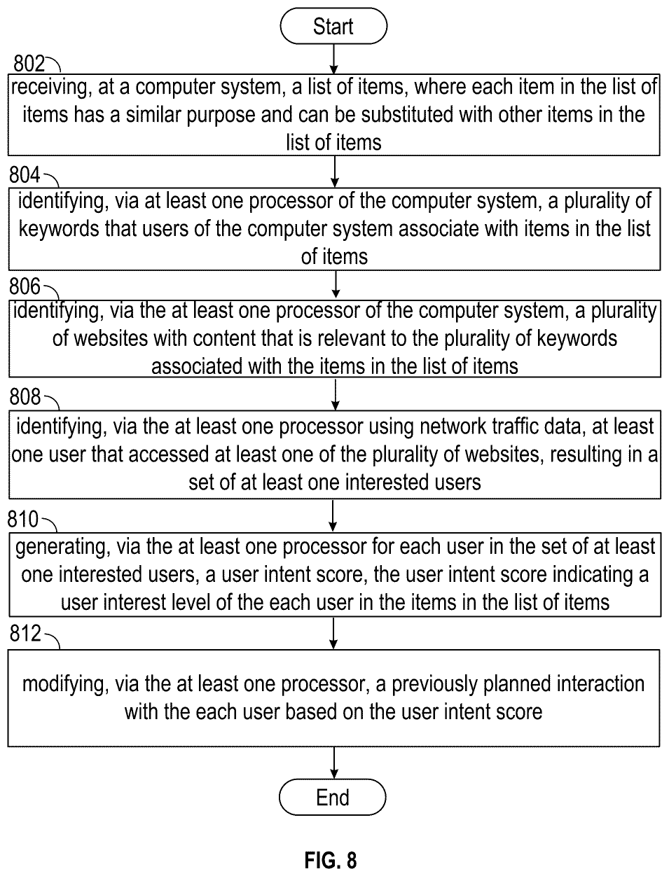

FIG. 8 illustrates a first example method embodiment. As illustrated, a computer system configured according to the principles disclosed herein can receiving, at a computer system, a list of items, where each item in the list of items has a similar purpose and can be substituted with other items in the list of items (802). The method continue by identifying, via at least one processor of the computer system, a plurality of keywords that users of the computer system associate with items in the list of items (804) and identifying, via the at least one processor of the computer system, a plurality of websites with content that is relevant to the plurality of keywords associated with the items in the list of items (806). The method can also include identifying, via the at least one processor using network traffic data, at least one user that accessed at least one of the plurality of websites, resulting in a set of at least one interested users (808) and generating, via the at least one processor for each user in the set of at least one interested users, a user intent score, the user intent score indicating a user interest level of the each user in the items in the list of items (810). The method can further include modifying, via the at least one processor, a previously planned interaction with the each user based on the user intent score (812).

In some configurations, the identifying of the plurality of keywords can be performed by a keyword analysis of search terms entered by users when accessing websites associated with the items in the list of items.

In some configurations, the identifying of the plurality of keywords can be performed by executing, via the at least one processor, a web scraping algorithm on a plurality of websites associated with items in the list of items.

In some configurations, the identifying of the plurality of websites can be performed by: analyzing search terms entered by users when accessing websites; and comparing those keywords to the plurality of keywords associated with the items in the list.

In some configurations, the identifying of the plurality of websites can be performed by: scraping, via a web scraping algorithm, words contained in the content of the websites by users; and correlating those words with the plurality of keywords associated with the items in the list of items.

In some configurations, the at least one user can comprise at least two users from a common organization; and the illustrated method can further include: generating, via the at least one processor, a common organization intent score for the common organization, the common organization intent score identifying an organizational interest in the list of items based on a correlation between the keywords and search terms used by the at least two users from the common organization to search for the at least one item, wherein the modifying of the communication for the at least two user is further based on the common organization intent score.

In some configurations, the illustrated method can further include receiving, from the at least one interested user, at least one user characteristic about the at least one interested user; and assigning a weight to each characteristic within the at least one user characteristic based on a relevancy of each characteristic to the list of items, resulting in weighted characteristics, wherein the modifying of the communication for the at least one interested user is further based on the weighted characteristics.

In some configurations, the illustrated method can further include periodically updating, via the at least one processor, the plurality of keywords.

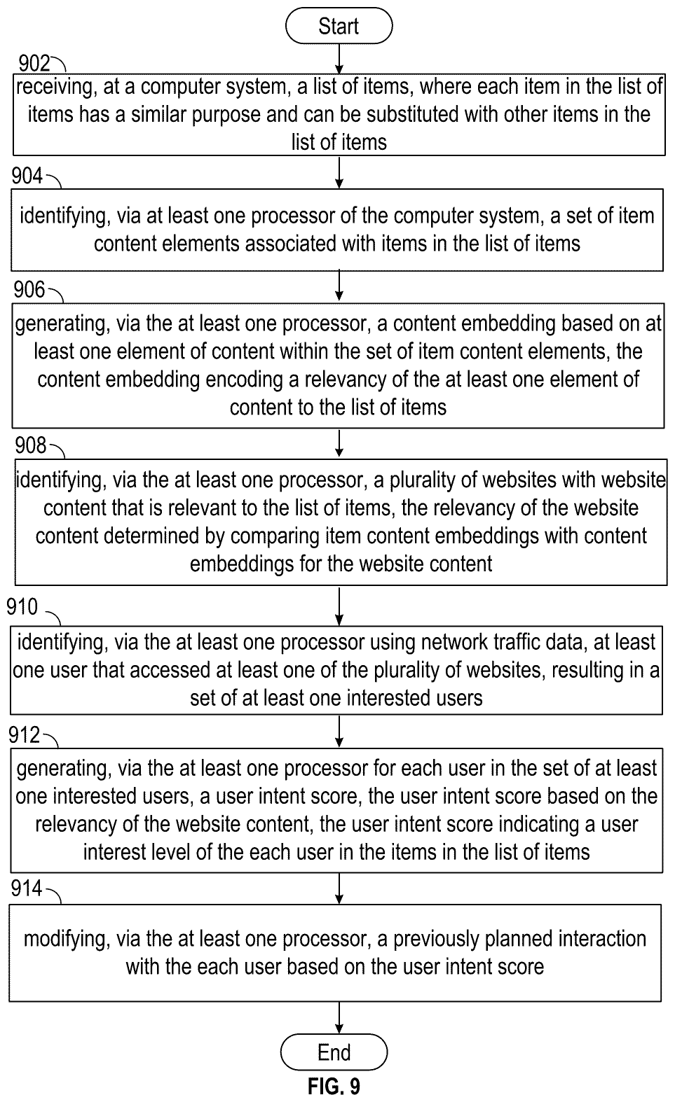

FIG. 9 illustrates a second example method embodiment. As illustrated, the method can include receiving, at a computer system, a list of items, where each item in the list of items has a similar purpose and can be substituted with other items in the list of items (902), and identifying, via at least one processor of the computer system, a set of item content elements associated with items in the list of items (904). The method can further include generating, via the at least one processor, a content embedding based on at least one element of content within the set of item content elements, the content embedding encoding a relevancy of the at least one element of content to the list of items (906) and identifying, via the at least one processor, a plurality of websites with website content that is relevant to the list of items, the relevancy of the website content determined by comparing item content embeddings with content embeddings for the website content (908). Next, the method can include identifying, via the at least one processor using network traffic data, at least one user that accessed at least one of the plurality of websites, resulting in a set of at least one interested users (910) and generating, via the at least one processor for each user in the set of at least one interested users, a user intent score, the user intent score based on the relevancy of the website content, the user intent score indicating a user interest level of the each user in the items in the list of items (912). Finally, the method can include modifying, via the at least one processor, a previously planned interaction with the each user based on the user intent score (914). The various permutations and variations described with respect to FIG. 8 can likewise apply to the method illustrated in FIG. 9.

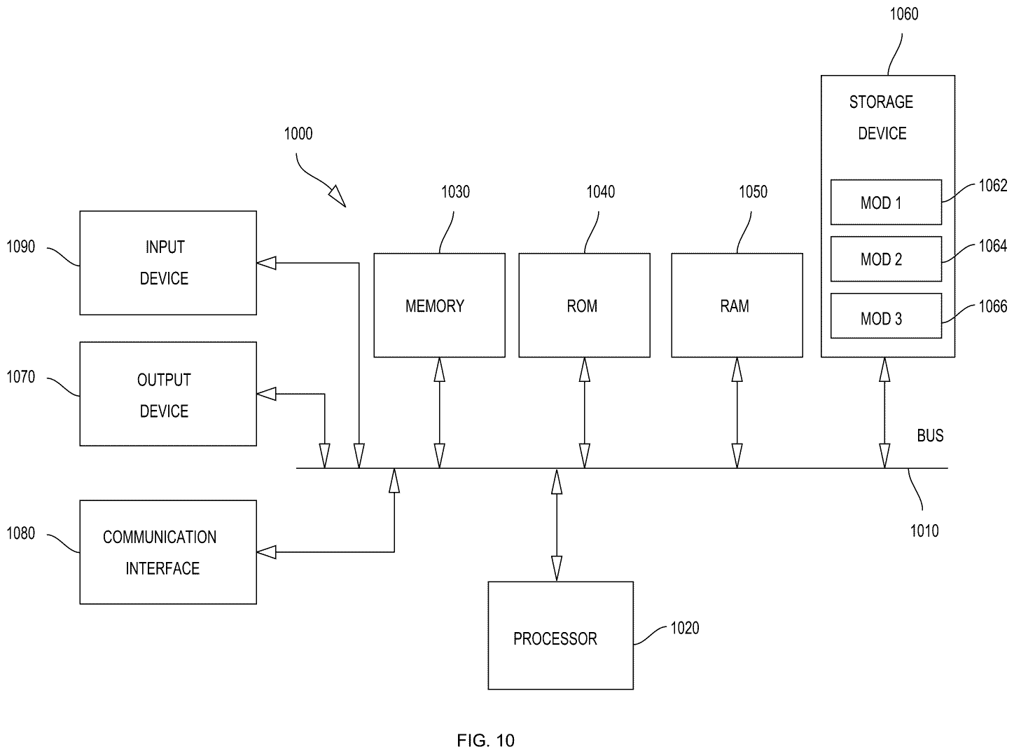

With reference to FIG. 10, an exemplary system includes a computing device 1000 (such as a general-purpose computing device), including a processing unit (CPU or processor) 1020 and a system bus 1010 that couples various system components including the system memory 1030 such as read-only memory (ROM) 1040 and random access memory (RAM) 1050 to the processor 1020. The computing device 1000 can include a cache of high-speed memory connected directly with, in close proximity to, or integrated as part of the processor 1020. The computing device 1000 copies data from the system memory 1030 and/or the storage device 1060 to the cache for quick access by the processor 1020. In this way, the cache provides a performance boost that avoids processor 1020 delays while waiting for data. These and other modules can control or be configured to control the processor 1020 to perform various actions. Other system memory 1030 may be available for use as well. The system memory 1030 can include multiple different types of memory with different performance characteristics. It can be appreciated that the disclosure may operate on a computing device 1000 with more than one processor 1020 or on a group or cluster of computing devices networked together to provide greater processing capability. The processor 1020 can include any general-purpose processor and a hardware module or software module, such as module 1 1062, module 2 1064, and module 3 1066 stored in storage device 1060, configured to control the processor 1020 as well as a special-purpose processor where software instructions are incorporated into the actual processor design. The processor 1020 may essentially be a completely self-contained computing system, containing multiple cores or processors, a bus, memory controller, cache, etc. A multi-core processor may be symmetric or asymmetric.

The system bus 1010 may be any of several types of bus structures including a memory bus or memory controller, a peripheral bus, and a local bus using any of a variety of bus architectures. A basic input/output (BIOS) stored in memory ROM 1040 or the like, may provide the basic routine that helps to transfer information between elements within the computing device 1000, such as during start-up. The computing device 1000 further includes storage devices 1060 such as a hard disk drive, a magnetic disk drive, an optical disk drive, tape drive or the like. The storage device 1060 can include software modules 1062, 1064, 1066 for controlling the processor 1020. Other hardware or software modules are contemplated. The storage device 1060 is connected to the system bus 1010 by a drive interface. The drives and the associated computer-readable storage media provide nonvolatile storage of computer-readable instructions, data structures, program modules and other data for the computing device 1000. In one aspect, a hardware module that performs a particular function includes the software component stored in a tangible computer-readable storage medium in connection with the necessary hardware components, such as the processor 1020, system bus 1010, output device 1070 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 1000 is a small, handheld computing device, a desktop computer, or a computer server.

Although the exemplary embodiment described herein employs the storage device 1060 (such as a hard disk), other types of computer-readable media which can store data that are accessible by a computer, such as magnetic cassettes, flash memory cards, digital versatile disks, cartridges, random access memories (RAMs) 1050, and read-only memory (ROM) 1040, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 1000, an input device 1090 represents any number of input mechanisms, such as a microphone for speech, a touch-sensitive screen for gesture or graphical input, keyboard, mouse, motion input, speech and so forth. An output device 1070 can also be one or more of a number of output mechanisms known to those of skill in the art. In some instances, multimodal systems enable a user to provide multiple types of input to communicate with the computing device 1000. The communications interface 1080 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a computer system, a list of items, where each item in the list of items has a similar purpose and can be substituted with other items in the list of items; identifying, via at least one processor of the computer system, a plurality of keywords that users of the computer system associate with items in the list of items; identifying, via the at least one processor of the computer system, a plurality of websites with content that is relevant to the plurality of keywords associated with the items in the list of items; identifying, via the at least one processor using network traffic data, at least one user that accessed at least one of the plurality of websites, resulting in a set of at least one interested users; generating, via the at least one processor for each user in the set of at least one interested users, a user intent score, the user intent score indicating a user interest level of the each user in the items in the list of items; and modifying, via the at least one processor, a previously planned interaction with the each user based on the user intent score.

The method of any preceding clause, wherein the identifying of the plurality of keywords is performed by a keyword analysis of search terms entered by users when accessing websites associated with the items in the list of items.

The method of any preceding clause, wherein the identifying of the plurality of keywords is performed by executing, via the at least one processor, a web scraping algorithm on a plurality of websites associated with items in the list of items.

The method of any preceding clause, where the identifying of the plurality of websites is performed by: analyzing search terms entered by users when accessing websites; and comparing those keywords to the plurality of keywords associated with the items in the list.

The method of any preceding clause, where the identifying of the plurality of websites is performed by: scraping, via a web scraping algorithm, words contained in the website content of the websites by users; and correlating those words with the plurality of keywords associated with the items in the list of items.

The method of any preceding clause, wherein the at least one user comprises at least two users from a common organization; and wherein the method further comprises: generating, via the at least one processor, a common organization intent score for the common organization, the common organization intent score identifying an organizational interest in the list of items based on a correlation between the keywords and search terms used by the at least two users from the common organization to search for at least one item in the list of items, wherein the modifying of the previously planned interaction for the at least two user is further based on the common organization intent score.

The method of any preceding clause, further comprising: receiving, from the set of at least one interested users, at least one user characteristic about the set of at least one interested users; and assigning a weight to each characteristic within the at least one user characteristic based on a relevancy of each characteristic to the list of items, resulting in weighted characteristics, wherein the modifying of the previously planned interaction for the set of at least one interested users is further based on the weighted characteristics.

The method of any preceding clause, further comprising: periodically updating, via the at least one processor, the plurality of keywords.

A system comprising: at least one processor; and a non-transitory computer-readable storage medium having instructions stored which, when executed by the at least one processor, cause the at least one processor to perform operations comprising: receiving a list of items, where each item in the list of items has a similar purpose and can be substituted with other items in the list of items; identifying a plurality of keywords that users of the system associate with items in the list of items; identifying a plurality of websites with content that is relevant to the plurality of keywords associated with the items in the list of items; identifying, using network traffic data, at least one user that accessed at least one of the plurality of websites, resulting in a set of at least one interested users; generating, for each user in the set of at least one interested users, a user intent score, the user intent score indicating a user interest level of the each user in the items in the list of items; and modifying a previously planned interaction with the each user based on the user intent score.

The system of any preceding clause, wherein the identifying of the plurality of keywords is performed by a keyword analysis of search terms entered by users when accessing websites associated with the items in the list of items.

The system of any preceding clause, wherein the identifying of the plurality of keywords is performed by executing, via the at least one processor, a web scraping algorithm on a plurality of websites associated with items in the list of items.

The system of any preceding clause, where the identifying of the plurality of websites is performed by: analyzing search terms entered by users when accessing websites; and comparing those keywords to the plurality of keywords associated with the items in the list.

The system of any preceding clause, where the identifying of the plurality of websites is performed by: scraping, via a web scraping algorithm, words contained in the website content of the websites by users; and correlating those words with the plurality of keywords associated with the items in the list of items.

The system of any preceding clause, wherein the at least one user comprises at least two users from a common organization; and wherein the non-transitory computer-readable storage medium has additional instructions stored which, when executed by the at least one processor, cause the at least one processor to perform operations comprising: generating a common organization intent score for the common organization, the common organization intent score identifying an organizational interest in the list of items based on a correlation between the keywords and search terms used by the at least two users from the common organization to search for at least one item in the list of items, wherein the modifying of the previously planned interaction for the at least two user is further based on the common organization intent score.

The system of any preceding clause, the non-transitory computer-readable storage medium having additional instructions stored which, when executed by the at least one processor, cause the at least one processor to perform operations comprising: receiving, from the set of at least one interested users, at least one user characteristic about the set of at least one interested users; and assigning a weight to each characteristic within the at least one user characteristic based on a relevancy of each characteristic to the list of items, resulting in weighted characteristics, wherein the modifying of the previously planned interaction for the set of at least one interested users is further based on the weighted characteristics.

The system of any preceding clause, the non-transitory computer-readable storage medium having additional instructions stored which, when executed by the at least one processor, cause the at least one processor to perform operations comprising: periodically updating, via the at least one processor, the plurality of keywords.

A non-transitory computer-readable storage medium having instructions stored which, when executed by at least one processor, cause the at least one processor to perform operations comprising: receiving a list of items, where each item in the list of items has a similar purpose and can be substituted with other items in the list of items; identifying a plurality of keywords that users associate with items in the list of items; identifying a plurality of websites with content that is relevant to the plurality of keywords associated with the items in the list of items; identifying, using network traffic data, at least one user that accessed at least one of the plurality of websites, resulting in a set of at least one interested users; generating, for each user in the set of at least one interested users, a user intent score, the user intent score indicating a user interest level of the each user in the items in the list of items; and modifying a previously planned interaction with the each user based on the user intent score.

A non-transitory computer-readable storage medium of any preceding clause, wherein the identifying of the plurality of keywords is performed by a keyword analysis of search terms entered by users when accessing websites associated with the items in the list of items.

A non-transitory computer-readable storage medium of any preceding clause, wherein the identifying of the plurality of keywords is performed by executing, via the at least one processor, a web scraping algorithm on a plurality of websites associated with items in the list of items.

A non-transitory computer-readable storage medium of any preceding clause, where the identifying of the plurality of websites is performed by: analyzing search terms entered by users when accessing websites; and comparing those keywords to the plurality of keywords associated with the items in the list.

A method comprising: receiving, at a computer system, a list of items, where each item in the list of items has a similar purpose and can be substituted with other items in the list of items; identifying, via at least one processor of the computer system, a set of item content elements associated with items in the list of items; generating, via the at least one processor, a content embedding based on at least one element of content within the set of item content elements, the content embedding encoding a relevancy of the at least one element of content to the list of items; identifying, via the at least one processor, a plurality of websites with website content that is relevant to the list of items, the relevancy of the website content determined by comparing item content embeddings with content embeddings for the website content; identifying, via the at least one processor using network traffic data, at least one user that accessed at least one of the plurality of websites, resulting in a set of at least one interested users; generating, via the at least one processor for each user in the set of at least one interested users, a user intent score, the user intent score based on the relevancy of the website content, the user intent score indicating a user interest level of the each user in the items in the list of items; and modifying, via the at least one processor, a previously planned interaction with the each user based on the user intent score.

The method of any preceding clause, wherein the comparing of item content embeddings with content embeddings for the website content is done via an embedding distance measurement.

The method of any preceding clause, wherein the embedding distance measurement comprises a Cosine distance.

The method of any preceding clause, where the identifying of at least one user that accessed at least one of the plurality of websites is accomplished by comparing a list of known website addresses to a list of websites accessed by the at least one user.

The method of any preceding clause, where the identifying of the plurality of websites is performed by: scraping, via a web scraping algorithm, words contained in the website content of the websites by users; and correlating those words with embeddings associated with the items in the list of items.

The method of any preceding clause, wherein the at least one user comprises at least two users from a common organization; and wherein the method further comprises: generating, via the at least one processor, a common organization intent score for the common organization, the common organization intent score identifying an organizational interest in the list of items based on a correlation between websites and search terms used by the at least two users from the common organization to search for at least one item in the list of items, wherein the modifying of the previously planned interaction for the at least two user is further based on the common organization intent score.

The method of any preceding clause, further comprising: receiving, from the set of at least one interested users, at least one user characteristic about the set of at least one interested users; and assigning a weight to each characteristic within the at least one user characteristic based on a relevancy of each characteristic to the list of items, resulting in weighted characteristics, wherein the modifying of the previously planned interaction for the set of at least one interested users is further based on the weighted characteristics.

The method of any preceding clause, further comprising: periodically updating, via the at least one processor, the plurality of websites.

A system comprising: at least one processor; and a non-transitory computer-readable storage medium having instructions stored which, when executed by the at least one processor, cause the at least one processor to perform operations comprising: receiving a list of items, where each item in the list of items has a similar purpose and can be substituted with other items in the list of items; identifying a set of item content elements associated with items in the list of items; generating a content embedding based on at least one element of content within the set of item content elements, the content embedding encoding a relevancy of the at least one element of content to the list of items; identifying a plurality of websites with website content that is relevant to the list of items, the relevancy of the website content determined by comparing item content embeddings with content embeddings for the website content; identifying, using network traffic data, at least one user that accessed at least one of the plurality of websites, resulting in a set of at least one interested users; generating, for each user in the set of at least one interested users, a user intent score, the user intent score based on the relevancy of the website content, the user intent score indicating a user interest level of the each user in the items in the list of items; and modifying a previously planned interaction with the each user based on the user intent score.

The system of any preceding clause, wherein the comparing of item content embeddings with content embeddings for the website content is done via an embedding distance measurement.

The system of any preceding clause, wherein the embedding distance measurement comprises a Cosine distance.

The system of any preceding clause, identifying of at least one user that accessed at least one of the plurality of websites is accomplished by comparing a list of known website addresses to a list of websites accessed by the at least one user.

The system of any preceding clause, where the identifying of the plurality of websites is performed by: scraping, via a web scraping algorithm, words contained in the website content of the websites by users; and correlating those words with embeddings associated with the items in the list of items.

The system of any preceding clause, wherein the at least one user comprises at least two users from a common organization; and wherein the non-transitory computer-readable storage medium has additional instructions stored which, when executed by the at least one processor, cause the at least one processor to perform operations comprising: generating a common organization intent score for the common organization, the common organization intent score identifying an organizational interest in the list of items based on a correlation between the websites and search terms used by the at least two users from the common organization to search for at least one item in the list of items, wherein the modifying of the previously planned interaction for the at least two user is further based on the common organization intent score.

The system of any preceding clause, the non-transitory computer-readable storage medium having additional instructions stored which, when executed by the at least one processor, cause the at least one processor to perform operations comprising: receiving, from the set of at least one interested users, at least one user characteristic about the set of at least one interested users; and assigning a weight to each characteristic within the at least one user characteristic based on a relevancy of each characteristic to the list of items, resulting in weighted characteristics, wherein the modifying of the previously planned interaction for the set of at least one interested users is further based on the weighted characteristics.

The system of any preceding clause, the non-transitory computer-readable storage medium having additional instructions stored which, when executed by the at least one processor, cause the at least one processor to perform operations comprising: periodically updating, via the at least one processor, the plurality of websites.

A non-transitory computer-readable storage medium having instructions stored which, when executed by at least one processor, cause the at least one processor to perform operations comprising: receiving a list of items, where each item in the list of items has a similar purpose and can be substituted with other items in the list of items; identifying a set of item content elements associated with items in the list of items; generating a content embedding based on at least one element of content within the set of item content elements, the content embedding encoding a relevancy of the at least one element of content to the list of items; identifying a plurality of websites with website content that is relevant to the list of items, the relevancy of the website content determined by comparing item content embeddings with content embeddings for the website content; identifying, using network traffic data, at least one user that accessed at least one of the plurality of websites, resulting in a set of at least one interested users; generating, for each user in the set of at least one interested users, a user intent score, the user intent score based on the relevancy of the website content, the user intent score indicating a user interest level of the each user in the items in the list of items; and modifying a previously planned interaction with the each user based on the user intent score.

The non-transitory computer-readable storage medium of any preceding clause, wherein the comparing of item content embeddings with content embeddings for the website content is done via an embedding distance measurement.

The non-transitory computer-readable storage medium of any preceding clause, wherein the embedding distance measurement comprises a Cosine distance.

The non-transitory computer-readable storage medium of any preceding clause. wherein identifying of at least one user that accessed at least one of the plurality of websites is accomplished by comparing a list of known website addresses to a list of websites accessed by the at least one user.

We claim:

1. A method comprising:
receiving, at a computer system, a list of items, where each item in the list of items has a similar purpose and can be substituted with other items in the list of items;
identifying, via at least one processor of the computer system, a plurality of keywords that users of the computer system associate with items in the list of items;
identifying, via the at least one processor of the computer system, a plurality of websites with content that is relevant to the plurality of keywords associated with the items in the list of items;
identifying, via the at least one processor using network traffic data, at least one user that accessed at least one of the plurality of websites, resulting in a set of at least one interested users;
generating, via the at least one processor for each user in the set of at least one interested users, a user intent score, the user intent score indicating a user interest level of the each user in the items in the list of items; and
modifying, via the at least one processor, a previously planned interaction with the each user based on the user intent score.

2. The method of claim 1, wherein the identifying of the plurality of keywords is performed by a keyword analysis of search terms entered by users when accessing websites associated with the items in the list of items.

3. The method of claim 1, wherein the identifying of the plurality of keywords is performed by executing, via the at least one processor, a web scraping algorithm on a plurality of websites associated with items in the list of items.

4. The method of claim 1, where the identifying of the plurality of websites is performed by:
analyzing search terms entered by users when accessing websites; and
comparing those keywords to the plurality of keywords associated with the items in the list.

5. The method of claim 1, where the identifying of the plurality of websites is performed by:
scraping, via a web scraping algorithm, words contained in the content of the websites by users; and
correlating those words with the plurality of keywords associated with the items in the list of items.

6. The method of claim 1, wherein the at least one user comprises at least two users from a common organization; and
wherein the method further comprises:
generating, via the at least one processor, a common organization intent score for the common organization, the common organization intent score identifying an organizational interest in the list of items based on a correlation between the keywords and search terms used by the at least two users from the common organization to search for at least one item in the list of items,
wherein the modifying of the previously planned interaction for the at least two user is further based on the common organization intent score.

7. The method of claim 1, further comprising:
receiving, from the set of at least one interested users, at least one user characteristic about the set of at least one interested users; and
assigning a weight to each characteristic within the at least one user characteristic based on a relevancy of each characteristic to the list of items, resulting in weighted characteristics,
wherein the modifying of the previously planned interaction for the set of at least one interested users is further based on the weighted characteristics.

8. The method of claim 1, further comprising:
periodically updating, via the at least one processor, the plurality of keywords.

9. A system comprising:
at least one processor; and
a non-transitory computer-readable storage medium having instructions stored which, when executed by the at least one processor, cause the at least one processor to perform operations comprising:
receiving a list of items, where each item in the list of items has a similar purpose and can be substituted with other items in the list of items;
identifying a plurality of keywords that users of the system associate with items in the list of items;
identifying a plurality of websites with content that is relevant to the plurality of keywords associated with the items in the list of items;
identifying, using network traffic data, at least one user that accessed at least one of the plurality of websites, resulting in a set of at least one interested users;
generating, for each user in the set of at least one interested users, a user intent score, the user intent score indicating a user interest level of the each user in the items in the list of items; and
modifying a previously planned interaction with the each user based on the user intent score.

10. The system of claim 9, wherein the identifying of the plurality of keywords is performed by a keyword analysis of search terms entered by users when accessing websites associated with the items in the list of items.

11. The system of claim 9, wherein the identifying of the plurality of keywords is performed by executing, via the at least one processor, a web scraping algorithm on a plurality of websites associated with items in the list of items.

12. The system of claim 9, where the identifying of the plurality of websites is performed by:
analyzing search terms entered by users when accessing websites; and
comparing those keywords to the plurality of keywords associated with the items in the list.

13. The system of claim 9, where the identifying of the plurality of websites is performed by:
scraping, via a web scraping algorithm, words contained in the content of the websites by users; and
correlating those words with the plurality of keywords associated with the items in the list of items.

14. The system of claim 9, wherein the at least one user comprises at least two users from a common organization; and
wherein the non-transitory computer-readable storage medium has additional instructions stored which, when executed by the at least one processor, cause the at least one processor to perform operations comprising:
generating a common organization intent score for the common organization, the common organization intent score identifying an organizational interest in the list of items based on a correlation between the keywords and search terms used by the at least two users from the common organization to search for at least one item in the list of items,
wherein the modifying of the previously planned interaction for the at least two user is further based on the common organization intent score.

15. The system of claim 9, the non-transitory computer-readable storage medium having additional instructions stored which, when executed by the at least one processor, cause the at least one processor to perform operations comprising:
receiving, from the set of at least one interested users, at least one user characteristic about the set of at least one interested users; and
assigning a weight to each characteristic within the at least one user characteristic based on a relevancy of each characteristic to the list of items, resulting in weighted characteristics,
wherein the modifying of the previously planned interaction for the set of at least one interested users is further based on the weighted characteristics.

16. The system of claim 9, the non-transitory computer-readable storage medium having additional instructions stored which, when executed by the at least one processor, cause the at least one processor to perform operations comprising:
periodically updating, via the at least one processor, the plurality of keywords.

17. A non-transitory computer-readable storage medium having instructions stored which, when executed by at least one processor, cause the at least one processor to perform operations comprising:
receiving a list of items, where each item in the list of items has a similar purpose and can be substituted with other items in the list of items;
identifying a plurality of keywords that users associate with items in the list of items;
identifying a plurality of websites with content that is relevant to the plurality of keywords associated with the items in the list of items;
identifying, using network traffic data, at least one user that accessed at least one of the plurality of websites, resulting in a set of at least one interested users;
generating, for each user in the set of at least one interested users, a user intent score, the user intent score indicating a user interest level of the each user in the items in the list of items; and
modifying a previously planned interaction with the each user based on the user intent score.

18. The non-transitory computer-readable storage medium of claim 17, wherein the identifying of the plurality of keywords is performed by a keyword analysis of search terms entered by users when accessing websites associated with the items in the list of items.

19. The non-transitory computer-readable storage medium of claim 17, wherein the identifying of the plurality of keywords is performed by executing, via the at least one processor, a web scraping algorithm on a plurality of websites associated with items in the list of items.

20. The non-transitory computer-readable storage medium of claim 17, where the identifying of the plurality of websites is performed by:
analyzing search terms entered by users when accessing websites; and
comparing those keywords to the plurality of keywords associated with the items in the list.

21. A method comprising:
receiving, at a computer system, a list of items, where each item in the list of items has a similar purpose and can be substituted with other items in the list of items;
identifying, via at least one processor of the computer system, a set of item content elements associated with items in the list of items;
generating, via the at least one processor, a content embedding based on at least one element of content within the set of item content elements, the content embedding encoding a relevancy of the at least one element of content to the list of items;
identifying, via the at least one processor, a plurality of websites with website content that is relevant to the list of items, the relevancy of the website content determined by comparing item content embeddings with content embeddings for the website content;
identifying, via the at least one processor using network traffic data, at least one user that accessed at least one of the plurality of websites, resulting in a set of at least one interested users;
generating, via the at least one processor for each user in the set of at least one interested users, a user intent score, the user intent score based on the relevancy of the website content, the user intent score indicating a user interest level of the each user in the items in the list of items; and
modifying, via the at least one processor, a previously planned interaction with the each user based on the user intent score.

22. The method of claim 21, wherein the comparing of item content embeddings with content embeddings for the website content is done via an embedding distance measurement.

23. The method of claim 22, wherein the embedding distance measurement comprises a Cosine distance.

24. The method of claim 21, where the identifying of at least one user that accessed at least one of the plurality of websites is accomplished by comparing a list of known website addresses to a list of websites accessed by the at least one user.

25. The method of claim 21, where the identifying of the plurality of websites is performed by:
scraping, via a web scraping algorithm, words contained in the website content of the websites by users; and
correlating those words with embeddings associated with the items in the list of items.

26. The method of claim 21, wherein the at least one user comprises at least two users from a common organization; and
wherein the method further comprises:
generating, via the at least one processor, a common organization intent score for the common organization, the common organization intent score identifying an organizational interest in the list of items based on a correlation between websites and search terms used by the at least two users from the common organization to search for at least one item in the list of items,
wherein the modifying of the previously planned interaction for the at least two user is further based on the common organization intent score.

27. The method of claim 21, further comprising:
receiving, from the set of at least one interested users, at least one user characteristic about the set of at least one interested users; and
assigning a weight to each characteristic within the at least one user characteristic based on a relevancy of each characteristic to the list of items, resulting in weighted characteristics,
wherein the modifying of the previously planned interaction for the set of at least one interested users is further based on the weighted characteristics.

28. The method of claim 21, further comprising:
periodically updating, via the at least one processor, the plurality of websites.

29. A system comprising:
at least one processor; and
a non-transitory computer-readable storage medium having instructions stored which, when executed by the at least one processor, cause the at least one processor to perform operations comprising:
receiving a list of items, where each item in the list of items has a similar purpose and can be substituted with other items in the list of items;
identifying a set of item content elements associated with items in the list of items;
generating a content embedding based on at least one element of content within the set of item content elements, the content embedding encoding a relevancy of the at least one element of content to the list of items;
identifying a plurality of websites with website content that is relevant to the list of items, the relevancy of the website content determined by comparing item content embeddings with content embeddings for the website content;
identifying, using network traffic data, at least one user that accessed at least one of the plurality of websites, resulting in a set of at least one interested users;
generating, for each user in the set of at least one interested users, a user intent score, the user intent score based on the relevancy of the website content, the user intent score indicating a user interest level of the each user in the items in the list of items; and
modifying a previously planned interaction with the each user based on the user intent score.

30. The system of claim 29, wherein the comparing of item content embeddings with content embeddings for the website content is done via an embedding distance measurement.

31. The system of claim 30, wherein the embedding distance measurement comprises a Cosine distance.

32. The system of claim 29, identifying of at least one user that accessed at least one of the plurality of websites is accomplished by comparing a list of known website addresses to a list of websites accessed by the at least one user.

33. The system of claim 29, where the identifying of the plurality of websites is performed by:
scraping, via a web scraping algorithm, words contained in the website content of the websites by users; and
correlating those words with embeddings associated with the items in the list of items.

34. The system of claim 29, wherein the at least one user comprises at least two users from a common organization; and
wherein the non-transitory computer-readable storage medium has additional instructions stored which, when executed by the at least one processor, cause the at least one processor to perform operations comprising:
generating a common organization intent score for the common organization, the common organization intent score identifying an organizational interest in the list of items based on a correlation between the websites and search terms used by the at least two users from the common organization to search for at least one item in the list of items,
wherein the modifying of the previously planned interaction for the at least two user is further based on the common organization intent score.

35. The system of claim 29, the non-transitory computer-readable storage medium having additional instructions stored which, when executed by the at least one processor, cause the at least one processor to perform operations comprising:
receiving, from the set of at least one interested users, at least one user characteristic about the set of at least one interested users; and
assigning a weight to each characteristic within the at least one user characteristic based on a relevancy of each characteristic to the list of items, resulting in weighted characteristics,
wherein the modifying of the previously planned interaction for the set of at least one interested users is further based on the weighted characteristics.

36. The system of claim 29, the non-transitory computer-readable storage medium having additional instructions stored which, when executed by the at least one processor, cause the at least one processor to perform operations comprising:
periodically updating, via the at least one processor, the plurality of websites.

37. A non-transitory computer-readable storage medium having instructions stored which, when executed by at least one processor, cause the at least one processor to perform operations comprising:
receiving a list of items, where each item in the list of items has a similar purpose and can be substituted with other items in the list of items;
identifying a set of item content elements associated with items in the list of items;
generating a content embedding based on at least one element of content within the set of item content elements, the content embedding encoding a relevancy of the at least one element of content to the list of items;
identifying a plurality of websites with website content that is relevant to the list of items, the relevancy of the website content determined by comparing item content embeddings with content embeddings for the website content;
identifying, using network traffic data, at least one user that accessed at least one of the plurality of websites, resulting in a set of at least one interested users;
generating, for each user in the set of at least one interested users, a user intent score, the user intent score based on the relevancy of the website content, the user intent score indicating a user interest level of the each user in the items in the list of items; and
modifying a previously planned interaction with the each user based on the user intent score.

38. The non-transitory computer-readable storage medium of claim 37, wherein the comparing of item content embeddings with content embeddings for the website content is done via an embedding distance measurement.

39. The non-transitory computer-readable storage medium of claim 38, wherein the embedding distance measurement comprises a Cosine distance.

40. The non-transitory computer-readable storage medium of claim 37, wherein identifying of at least one user that accessed at least one of the plurality of websites is accomplished by comparing a list of known website addresses to a list of websites accessed by the at least one user.
